(19) United States
(12) Patent Application Publication
(10) Pub. No.: US 2014/0372691 A1
(43) Pub. Date: Dec. 18, 2014

(54) COUNTER POLICY IMPLEMENTATION

(71) Applicant: Hewlett-Packard Development Company, L. P., Houston, TX (US)

(72) Inventor: Steven Glen Jorgensen, Newcastle, CA (US)

(21) Appl. No.: 13/917,369

(22) Filed: Jun. 13, 2013

(51) Int. Cl. G06F 12/00

(52) U.S. Cl. CPC G06F 12/00
USPC 711/105

(57) ABSTRACT

According to an example, a counter policy implementation apparatus may include a policy determination module to receive a counter address for a local counter and to map the counter address to a specific policy of a plurality of policies, and a policy application module to receive a posted value and a double data rate (DDR) value associated with the local counter. The policy application module may include a comparator to compare the posted value or the DDR value with a maximum value associated with the local counter specified in the mapped policy, and an action block to perform an action specified by the mapped policy based on the comparison.

### BACKGROUND

An application specific integrated circuit (ASIC) is an integrated circuit (IC) that is typically customized for a particular use. ASICs generally include counters that count events associated with the particular use. Due to the size limitations of ASICs and the number of counters that can be supported by a given ASIC, count values stored in the ASIC counters (e.g., 32 bit or smaller counters) are polled by software to update one or more larger counters (e.g., 64 bit counters) in the central processing unit (CPU) main memory (i.e., the double data rate dynamic random-access memory (DDR DRAM)). For example, current count values stored in the ASIC counters are polled by software and then compared to the latest values in the DDR DRAM for the respective counters. Based on the difference between the latest values in the DDR DRAM and the current count values, the count values stored in the ASIC counters and DDR DRAM are updated. For example, a policy may include a maximum count value (e.g., a 1 count value that represents an error for a counter that otherwise remains at a 0 count value) that is applied to ASIC counters that monitor errors. When the ASIC counters are polled by software (e.g., at predetermined time intervals or when requested by the CPU), if one of the ASIC counters reaches the maximum count value, the software detects the change to the maximum count value during the polling cycle and informs the CPU.

### BRIEF DESCRIPTION OF DRAWINGS

Features of the present disclosure are illustrated by way of example and not limited in the following figure(s), in which like numerals indicate like elements, in which:

FIG. 1 illustrates an architecture of a counter policy implementation apparatus, according to an example of the present disclosure;

FIG. 2 illustrates further details of an architecture of a policy implementation module of the counter policy implementation apparatus, according to an example of the present disclosure;

FIG. 3 illustrates further details of an architecture of the policy implementation module of the counter policy implementation apparatus, according to an example of the present disclosure;

FIG. 4 illustrates a policies table used by the counter policy implementation apparatus, according to an example of the present disclosure;

FIG. 5 illustrates a method for counter policy implementation, according to an example of the present disclosure;

FIG. 6 illustrates further details of the method for counter policy implementation, according to an example of the present disclosure; and

FIG. 7 illustrates a computer system, according to an example of the present disclosure.

### DETAILED DESCRIPTION

For simplicity and illustrative purposes, the present disclosure is described by referring mainly to examples. In the following description, numerous specific details are set forth in order to provide a thorough understanding of the present disclosure. It will be readily apparent however, that the present disclosure may be practiced without limitation to these specific details. In other instances, some methods and structures have not been described in detail so as not to unnecessarily obscure the present disclosure.

Throughout the present disclosure, the terms “a” and “an” are intended to denote at least one of a particular element. As used herein, the term “includes” means includes but not limited to, the term “including” means including but not limited to. The term “based on” means based at least in part on.

In an ASIC that includes counters that count events, implementation of policies based on local counters being polled by software that also processes the polled count values to determine overall count values for counters in external memory can add, for example, unnecessary delay in the reporting of such polled count values, and unnecessary resource utilization. For example, policies may include a maximum count value (e.g., a 1 count value that represents an error for a counter that otherwise remains at a 0 count value) that is applied to ASIC counters that monitor errors. Policies may also include metering to check the rate of change for a counter, or a static maximum value if a counter ever reaches the maximum value. For an example of application of the maximum count value policy, typically, software is used to poll the ASIC counters to determine if one of the ASIC counters reaches the maximum count value. The polling can be performed, for example, at predetermined time intervals, or when requested by an application. For an ASIC that can include hundreds of thousands of such ASIC counters, unless one or more of the ASIC counters detects an error (i.e., reaches the maximum count value), each of the polling cycles results in a “no change detected” for the count value of the ASIC counters. Typically, such types of polling of the ASIC counters can occur several times per minute, or over a shorter time duration capable of being implemented in software. Therefore, unless a polled counter actually detects an error, the continuous polling at predetermined time intervals, or when requested by the CPU, results in unnecessary resource utilization. Further, for an ASIC that includes a significantly large number of the ASIC counters, such as hundreds of thousands of such ASIC counters, the time it takes for software to poll all of the ASIC counters, process the results, and then report the results to the CPU can cause unnecessary delay in the reporting and further processing of such polled count values. For example, for the foregoing example of the maximum count value policy, assuming an ASIC includes N-counters (e.g., 100,000 counters), if several thousand counters are polled before polling of a counter that has detected an error event, the time it takes for software to poll all of the ASIC counters before reaching the counter that has detected the error event can cause unnecessary delay in the detection, processing, and reporting of the error detection results to the CPU.

The need for software to poll local counters and the associated delay and resource utilization aspects may be eliminated by a counter policy implementation apparatus, and a method for counter policy implementation, as described herein. According to an example, the counter policy implementation apparatus may include a policy determination module to receive a counter address for a local counter and to map the counter address to a specific policy of a plurality of policies, and a policy application module to receive a posted value and a double data rate (DDR) value associated with the local counter. The policy application module may include a comparator to compare the posted value or the DDR value with a maximum value associated with the local counter specified in the mapped policy, and an action block to perform an action specified by the mapped policy based on the comparison.

Based, for example, on the detection of a counter update post from a local counter for a counter in external memory, a policy associated with the local counter and/or the counter in the external memory may be implemented virtually instantaneously in hardware, without the need for polling counters, or additional processing to determine counter values in the external memory. For example, based on the detection of a counter update post from a local counter for a counter in the external memory, policies, such as those associated with rate limits, may be applied in real time in hardware, without the time delays associated with polling of counters by software, or additional processing by software to determine counter values in the external memory. The method and apparatus as described herein also provide for granularity in the application of policies, for example, by application of policies to groups of local counters and/or counters in the external memory.

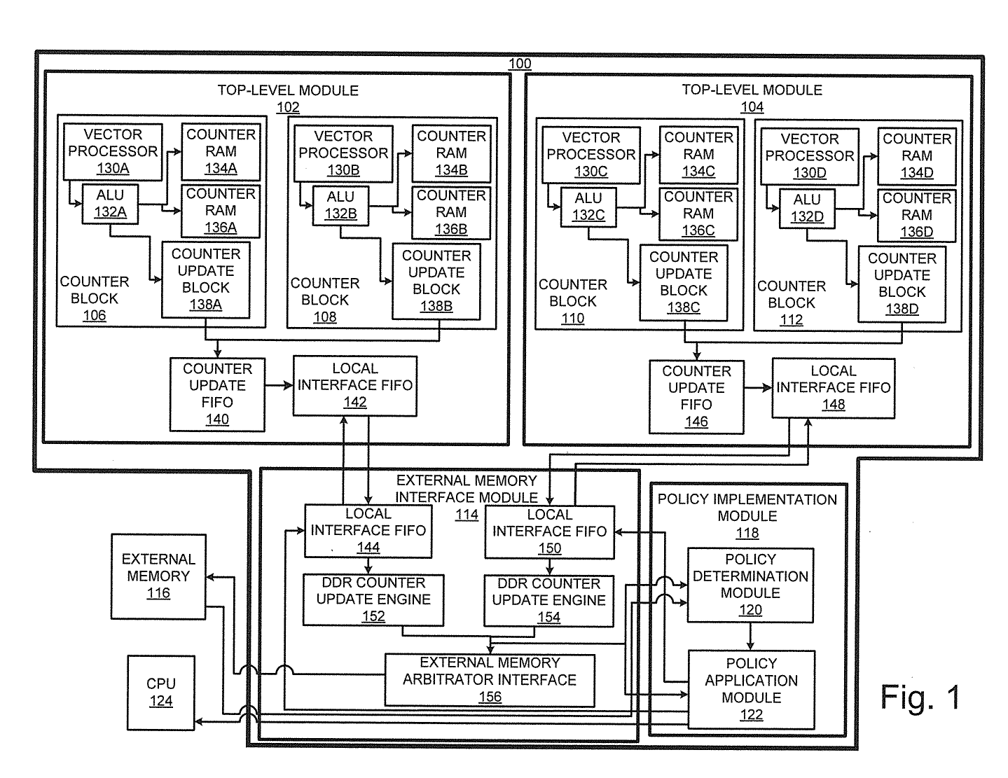

FIG. 1 illustrates an architecture of a counter policy implementation apparatus 100, according to an example. Referring to FIG. 1, the apparatus 100 is depicted as including top-level modules 102, 104 that include various components associated with internal (i.e., local) ASIC counters included in counter blocks 106, 108, 110, and 112. Although four counter blocks 106, 108, 110, and 112 are shown, those skilled in the art would appreciate in view of this disclosure that the number of counter blocks may vary depending on aspects such as the number of events to be monitored by the apparatus 100. Counter updates to the internal ASIC counters may be received by an external memory interface module 114 that posts the counter updates to one or more larger counters in external memory 116. Counter updates that are to be posted to the larger counters in the external memory 116 may be detected by a policy implementation module 118. Generally, the policy implementation module 118 may include a policy determination module 120 to determine, based on a counter update post, a policy associated with (i.e., assigned to) the particular internal ASIC counter associated with the counter update post, and/or a policy associated with a particular larger counter in the external memory 116 that is associated with the particular internal ASIC counter associated with the counter update post. Based on the particulars of a policy, the policy may be implemented based on any counter update posts associated with a particular internal ASIC counter, and/or based on the overall counter value of a set of counters in the external memory 116 that is associated with the particular internal ASIC counter. The policy implementation module 118 may further include a policy application module 122 that communicates with CPU 124 and/or the local interface FIFOs 144, 150, to implement policies associated with internal ASIC counters.

The modules 102, 104, 114, 118, 120, and 122, and other components of the apparatus 100 that perform various other functions in the apparatus 100, may comprise machine readable instructions stored on a non-transitory computer readable medium. In addition, or alternatively, the modules 102, 104, 114, 118, 120, and 122, and other components of the apparatus 100 may comprise hardware or a combination of machine readable instructions and hardware.

Referring to FIG. 1, the top-level modules 102, 104 may include various components associated with internal ASIC counters included in counter blocks 106, 108, 110, and 112. The counter blocks 106, 108, 110, and 112 may each include a unique identification (ID) associated therewith. The configuration of each of the counter blocks 106, 108, 110, and 112 is generally identical, and each of the counter blocks 106, 108, 110, and 112 includes an internal ASIC counter (e.g., 32 bit ASIC counter).

For example, the counter block 106 may include a vector processor 130A to receive a vector that is generated upon the occurrence of an event being monitored by the counter block 106. The vector processor 130A, via the arithmetic and logic unit (ALU) 132A, may update the counter RAMs 134A and 136A, each representing an internal ASIC counter used to count events being monitored by the counter block 106. The use of two counter RAMs 134A and 136A per update provides an optimization based on the large amounts of data monitored by the counter block 106. Alternatively, a single counter RAM may be used instead. The ALU 132A may perform a read, modify, and write operation on the counter RAMs 134A and 136A. The ALU 132A may process updates (i.e., incoming events) and flushing of the internal ASIC counters.

If an internal ASIC counter reaches or exceeds a predetermined count value (i.e., a count threshold) specified for the particular internal ASIC counter, the count value may be posted to counter update block 138A. For example, once the ALU 132A detects that counter RAMs 134A or 136A have met or exceeded a predetermined count value, the ALU 132A may post the count value to the counter update block 138A, and flush the counter RAMs 134A and 136A by writing a zero back to the counter RAMs 134A and 136A. If the ALU 132A detects that a counter RAM is nearly full after a read-modify-write action, the modified value for the particular counter RAM is forwarded to storage for a counter update. The counter update block 138A may communicate with the ALU 132A to determine if the counter update block 138A has sufficient room to store an update. The posted count values from the counter update blocks 138A and 138B (i.e., counter block 108) may be forwarded to a counter update FIFO (first in first out) 140. The counter update FIFO 140 may forward the posted count value to a local interface FIFO 142 for the top-level module 102. The local interface FIFO 142 communicates with local interface FIFO 144 for the external memory interface module 114. Counter blocks 108, 110, and 112 include components similar to counter block 106, and are therefore designated in a similar manner as shown in FIG. 1. For example, the vector processor 130A for counter block 106 is similarly designated as vector processors 130B, 130C, and 130D, for counter blocks 108, 110, and 112, respectively. Top-level module 104 may include counter update FIFO 146 similar to counter update FIFO 140 of the top-level module 102, and local interface FIFO 148 similar to local interface FIFO 142 of the top-level module 102. The local interface FIFO 148 of the top-level module 104 communicates with local interface FIFO 150 for the external memory interface module 114. The discussion below related to counter block 106 therefore similarly applies to counter blocks 108, 110, and 112.

As discussed herein, the ALU 132A may perform a read, modify, and write operation on the counter RAMs 134A and 136A. If the ALU 132A determines that the counters RAM 134A and 136A may wrap after being modified, the ALU 132A forwards a modified value for counter RAMs 134A and 136A and an offset, to the counter update block 138A. If the counter update block 138A includes sufficient space, the ALU 132A writes zero to the counter RAMs 134A and 136A, and if the counter update block 138A is full, the ALU 132A writes the modified value back to the counter RAMs 134A and 136A, and re-attempts the process upon occurrence of the next transaction to the counter RAMs 134A and 136A.

As discussed herein, if an internal ASIC counter meets or exceeds (i.e., based on the configuration of the ALU 132A) a predetermined count value (Le., a count threshold) specified for the particular internal ASIC counter, the count value may be posted to counter update block 138A. For example, once the ALU 132A detects that counter RAMs 134A and 136A have exceeded a predetermined count value, the ALU 132A may post the count value to the counter update block 138A, and the ALU 132A may further flush the counter RAMs 134A and 136A by writing a zero back to the counter RAMs 134A and 136A. However, for low traffic conditions, if a count value for an internal ASIC counter remains below a predetermined count value, which prevents the external memory 116 from being updated for an extended period, a forced flush may be initiated on the counter RAMs 134A, 136A. For example, based on expiration of a predetermined period of time, if a count value for an internal ASIC counter remains below a predetermined count value, a forced flush may be initiated on the counter RAMs 134A, 136A. A state machine may be used to scan each counter RAM 134A, 136A, and if the count value stored in the counter RAMs 134A and 136A is non-zero, the non-zero count value may be transferred to the counter update block 138A if the counter update block 138A is available. If the counter update block 138A is not available, the state machine may re-try the flush operation for the counter block 106.

The counter blocks 106, 108, 110, and 112 may maintain a set of dirty bits representing a segment of counter space. The dirty bits may be used to determine which counters have been updated. For example, when a counter is updated, the dirty bit representing that segment of counter space is set. When a counter is flushed, the dirty bit representing that segment of counter space is latched and the internal bits are cleared to be set by counter updates during a flush period. The latched bits may be presented to a register read interface, and may be used by a flush state machine to determine which segments to flush. The latched bits may also be used to determine which counters have been updated.

With respect to the external memory interface module 114, any counter value updates received by the local interface FIFO 144 or the local interface FIFO 150 may be forwarded to DDR counter update engines 152, 154, respectively. Data received by the local interface FIFOs 144, 150 may include, for example, 2 bits for ALU operation type, 6 reserved bits, 8 bits for counter ID, 16 bits for counter offset, 24 bits upper counter data (i.e., counter RAM 134A for counter block 106), and 24 bits lower counter data (i.e., counter RAM 136A for counter block 106). The DDR counter update engines 152, 154 may determine aspects such as which of the counters from the top-level modules 102, 104 are associated with the counter value update.

Based on the determination by the DDR counter update engines 152, 154, the counter value update may be mapped to the appropriate memory location in the external memory 116. External memory arbitrator interface 156 may provide the DDR interface for posting the counter value update to the appropriate counter (e.g., 64 bit counter) and memory location in the external memory 116. For example, information from the local interface FIFOs 144, 150 may be used in a read-modify-write operation for two associated counters in the external memory 116. Thus, any counter value in the external memory 116 includes the sum of all counter value updates from the top-level modules 102, 104 that are posted to the appropriate counter and memory location in the external memory 116. As discussed herein, a value of zero is also returned to any counter associated with the counter value update to the top-level modules 102, 104 to reset the appropriate counter in the top-level modules 102, 104. Any counter value in the external memory 116 therefore includes the sum of all events that have occurred (e.g., the sum of all updates received by a particular counter in the top-level modules 102, 104) and are associated with a particular counter in the top-level modules 102, 104.

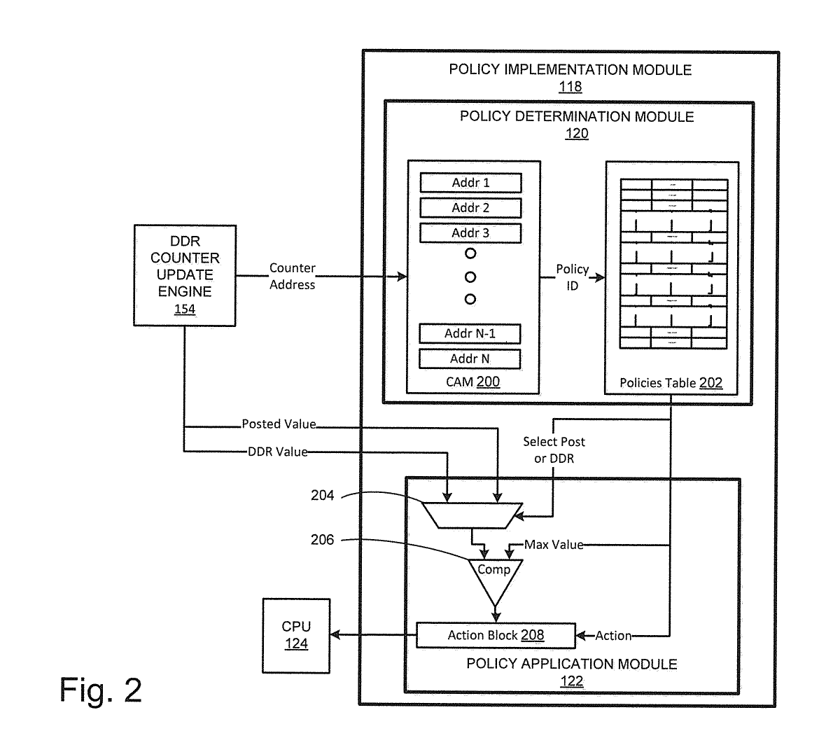

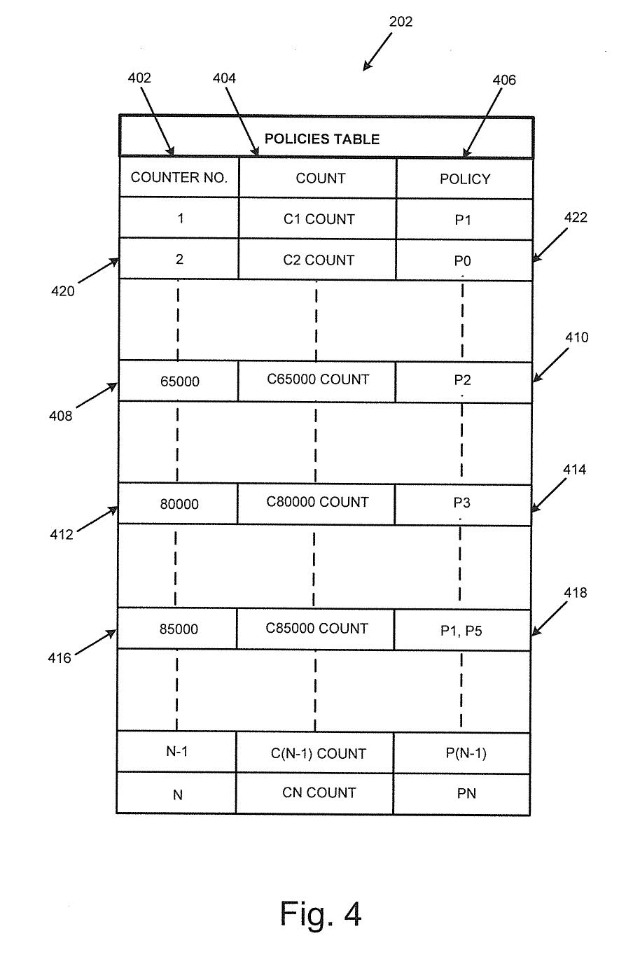

As discussed herein, the DDR counter update engines 152, 154 may determine aspects such as which of the counters from the top-level modules 102, 104 are associated with a counter value update. Referring to FIGS. 1 and 2, FIG. 2 illustrates further details of an architecture of the policy implementation module 118, according to an example of the present disclosure. With respect to a policy that implements a maximum count value (e.g., a maximum count value of 1, or a maximum count value greater than 1), the policy determination module 120 may receive a full counter address from the DDR counter update engine 154 (or the DDR counter update engine 152 as shown in FIG. 1) for a local counter of the top-level modules 102, 104 that is associated with the counter value update. The policy determination module 120 may use a content-addressable memory (CAM) (e.g., a lookup table, or a hash table) to map the counter address to a specific policy type in a policies table 202. The policies Table 202 may be located on the ASIC as shown in FIG. 1, or in the external memory 116. As illustrated in further detail in FIG. 4, the policies table 202 may include a counter number column 402, a count column 404, and a policy column 406. The count column 404 may include a count value associated with implementation of a policy in the policy column 406. The count column 404 may include a count value for an internal ASIC counter included in the counter blocks 106, 108, 110, and 112, or a count value for the associated larger counter in the external memory 116. For the example of a policy that implements a maximum count value, the policy may be a comparison policy type. The policy application module 122 may include a multiplexer 204 to receive a posted value and a DDR value from the DDR counter update engine 154. Based on the specific policy type that compares either a post value or a DDR value (i.e., as input at Select Post or DDR), the multiplexer 204 may forward the appropriate posted value and the DDR value to a comparator 206. Based on a comparison of the posted value or the DDR value from the DDR counter update engine 154 with a maximum value as specified in the mapped policy, the results of the comparison may be evaluated by an action block 208. The action block 208 may interrupt the CPU 124 and provide the address of the counter that violated the policy, and which policy is violated, or may stop traffic associated with that counter. Generally, the action block 208 may take any actions specified by the mapped policy and thus forward appropriate instructions to the CPU 124 if needed. For example, the action block 208 may indicate to the CPU 124 if the specific counter has changed (e.g., reached or surpassed a maximum value), and what type of action to perform per the mapped policy.

Referring to FIGS. 2 and 4, according to an example, for a policy that implements a maximum count value of 1 (e.g., a 1 count value that represents an error for a counter that otherwise remains at a 0 count value), the count column 404 may include a count value for an internal ASIC counter included in the counter blocks 106, 108, 110, and 112. For such a policy, if the count value for an internal ASIC counter changes from 0 to 1 (i.e., an error is detected), a counter update post may be detected by the policy implementation module 118 as discussed above with reference to FIG. 2. In this case, the policy determination module 120 may determine, based on the counter address, the policy associated with the particular internal ASIC counter associated with the counter update post. For the example of the policies table 202, assuming counter C65000 at 408 is associated with the counter update post, the policy determination module 120 may determine that policy P2 at 410 is associated with the counter C65000 at 408. Generally, based on the particulars of a policy, the policy may be implemented based on any counter update posts associated with a particular internal ASIC counter, or based on the overall counter value of the larger counter (i.e., DDR value) in the external memory 116 that is associated with the particular internal ASIC counter. For example, the policy P2 at 410 may be implemented by the policy application module 122 based on the counter update post associated with the internal ASIC counter C65000. In addition, if the policy P2 at 410 indicates a system restart based on the detection of the error by the counter C65000 at 408, the policy application module 122 may communicate with the CPU 124 via the action block 208 to implement the policy P2 at 410.

For the foregoing example of application of the policy P2 at 410 that implements a maximum count value of 1, the policy determination module 120 may use any count update posts from the internal ASIC counters included in counter blocks 106, 108, 110, and 112 as output from the DDR counter update engines 152, 154, instead of the count value for the larger associated counter in the external memory 116. This is because any count update posts from the internal ASIC counters included in counter blocks 106, 108, 110, and 112 as output from the DDR counter update engines 152, 154 automatically qualify for implementation of the policy P2 at 410, without the policy determination module 120 having to obtain the count value for the larger associated counter in the external memory 116, after the count update posts have been posted to the larger associated counter in the external memory 116.

Further, for the foregoing example of application of the maximum count value policy P2 at 410 that implements a maximum count value of 1, the need for software to poll local counters and the associated delay and resource utilization aspects may be eliminated by the counter policy implementation apparatus 100. For example, if software is used to poll the ASIC counters to determine if one of the ASIC counters reaches the maximum count value for implementation of the policy P2 at 410, the polling can be performed, for example, at predetermined time intervals, or when requested by the CPU 124. For an ASIC that can include hundreds of thousands of such ASIC counters, unless one or more of the ASIC counters detects an error (i.e., reaches the maximum count value of 1), each of the polling cycles results in a “no change detected” to the count value of the ASIC counters. Since such types of polling of the ASIC counters can occur several times per minute, or a shorter time duration capable of being implemented in software, unless a counter (e.g., the counter C65000 at 408) actually detects an error, the continuous polling at predetermined time intervals, or when requested by the CPU, results in unnecessary resource utilization. For an ASIC that can include hundreds of thousands of such ASIC counters, the time it takes for software to poll all of the ASIC counters, process the results, and then report the results to the CPU 124 can also cause unnecessary delay in the reporting and further processing of such polled count values. For example, for the foregoing example of the maximum count value policy P2 at 410, assuming an ASIC includes 100,000 counters (i.e., N=100,000 counters for the policies table 202), if the counter C65000 at 408 were to detect an error event, the time it takes for software to poll the ASIC counters C1 to C64999 before reaching counter C65000 at 408 can cause unnecessary delay in the detection, processing, and reporting of the count value results for the counter C65000 at 408 to the CPU. In this regard, based, for example, on the detection of a counter update post from the counter C65000 at 408 for an associated counter in the external memory 116, the policy P2 at 410 associated with the counter C65000 at 408 may be implemented virtually instantaneously, without the need for polling counters, or additional processing to determine counter values in the external memory 116.

According to another example, for a policy that implements a maximum count value greater than 1 (e.g., a 100 count value that is to be exceeded for policy implementation, or a static maximum count value of 101 for policy implementation), the count column 404 may include a count value for the associated larger counter in the external memory 116. Alternatively, as discussed herein, an intermediate source may be used to maintain overall count values from the internal ASIC counters included in counter blocks 106, 108, 110, and 112. For such a policy, if the count value for an internal ASIC counter changes from 10 to 11, a counter update post may be detected by the policy implementation module 118. In this case, the policy determination module 120 may determine, based on the counter address, the policy associated with the particular internal ASIC counter associated with the counter update post. For the example of the policies table 202, assuming counter C80000 at 412 is associated with the counter update post, the policy determination module 120 may determine that policy P3 at 414 is associated with the counter C80000 at 412. As discussed herein, generally, based on the particulars of a policy, the policy may be implemented based on any counter update posts associated with a particular internal ASIC counter, or based on the overall counter values of the larger counter in the external memory 116 that is associated with the particular internal ASIC counter. For example, since the policy P3 at 414 is based on a maximum count value exceeding 100 and the count value for the counter C80000 at 412 is less than 100 (i.e., the internal ASIC counter changes from 10 to 11), the count value for the counter C80000 at 412 is posted to the larger counter in the external memory 116. If the overall count value for the counter C80000 at 412 based on the associated larger counter in the external memory 116 exceeds 100, the policy P3 at 414 may be implemented by the action block 208 of the policy application module 122. For example, if the policy P3 at 414 indicates a system update based on the overall count value for the counter C80000 at 412 exceeding 100, the policy application module 122 may communicate with the CPU 124 to implement the policy P3 at 414.

For the foregoing example of a policy that implements a maximum count value greater than 1 (e.g., a 100 count value that is to be exceeded for policy implementation, or a static maximum value of 101 for policy implementation), the policy determination module 120 may use the count value for the larger counter in the external memory 116 associated with the internal ASIC counter(s) included in counter blocks 106, 108, 110, and 112. This is because any count update posts from the internal ASIC counters included in counter blocks 106, 108, 110, and 112 as output from the DDR counter update engines 152, 154 may not qualify for implementation of the policy P3 at 414, unless the count value for the larger counter in the external memory 116 associated with the internal ASIC counters included in counter blocks 106, 108, 110, and 112 also exceeds the maximum count value associated with the policy P3 at 414.

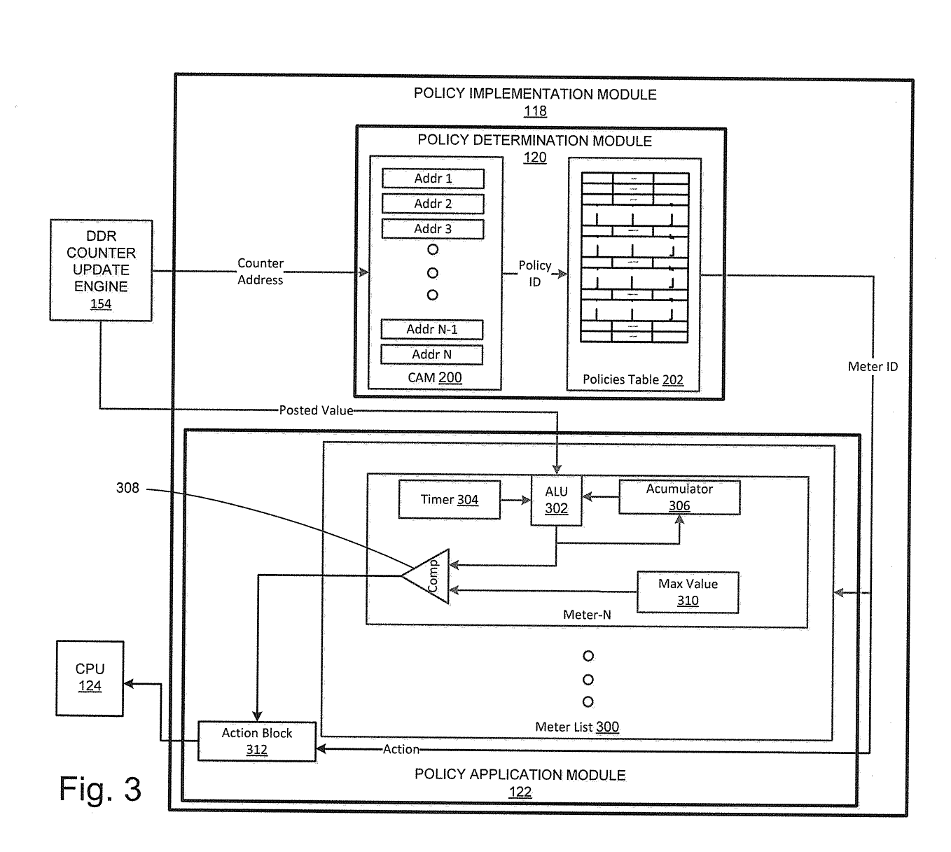

Referring to FIGS. 1 and 3, FIG. 3 illustrates further details of an architecture of the policy implementation module 118, according to an example of the present disclosure. With respect to a policy that implements metering to check the rate of change for a counter (e.g., less than 100 updates per second), the policy determination module 120 may receive a full counter address from the DDR counter update engine 154 (or the DDR counter update engine 152 as shown in FIG. 1) for a local counter of the top-level modules 102, 104 that is associated with the counter value update. The policy determination module 120 may use the CAM 200 to map the counter address to a specific policy type in the policies table 202. For the example of the policy that implements metering to check the rate of change for a counter, the policy may be a metering policy type. A meter identification (ID) associated with the mapped policy may be used to identify a specific meter from a meter list 300. A meter may include an ALU 302 that receives a posted value from the DDR counter update engine 154. The metered value from the ALU 302, which is based on an overall number of posts for a predetermined time period monitored by a timer 304 and stored in an accumulator 306, may be forwarded to a comparator 308. Based on a comparison of the metered value from the ALU 302 with a maximum metered value 310 (i.e., maximum rate) for the particular meter as specified in the mapped policy, the results of the comparison may be evaluated by an action block 312. The action block 312 may take any actions specified by the mapped policy and thus forward appropriate instructions to the CPU 124 if needed. For example, the action block 312 may indicate to the CPU 124 if the specific counter exceeds a rate of change, and what type of action to perform per the mapped policy.

Referring to FIGS. 3 and 4, according to an example, for policies that implement metering to check the rate of change for a counter (e.g., less than 100 updates per second), the count column 404 may include a count value for the associated larger counter in the external memory 116. For such a metering policy, if the count value for an internal ASIC counter within a predetermined time period is less than a predetermined rate of change (e.g., 50 updates per second), counter update posts may be detected by the policy implementation module 118. The policy determination module 120 may determine, based on the counter address, the policy associated with the particular internal ASIC counter associated with the counter update post. For the example of policies table 202, assuming the counter C85000 at 416 is associated with the counter update posts, the policy determination module 120 may determine that policies P1 and P5 at 418 are associated with the counter C85000 at 416. Since the policies P1 and P5 at 418 are based on a predetermined rate of change of less than 100 updates per second, and since the predetermined rate of change for the counter C85000 at 416 is less than 100 updates per second (i.e., 50 updates per second), the count value for the counter C85000 at 416 is posted to the larger counters in external memory 116. If the overall predetermined rate of change for the counter C85000 at 416 based on the associated larger counter in the external memory 116 exceeds 100 updates per second, the policies P1 and P5 at 418 may be implemented by the policy application module 122. For example, if the policies P1 and P5 at 418 respectively indicate shut-down of incoming traffic based on a possible denial-of-service (DOS) attack and redirection of further traffic due to the rate of change for the counter C85000 at 416 exceeding 100 updates per second, the policy application module 122 may communicate with the CPU 124 to implement the policies P1 and P5 at 418.

For the foregoing example of policies that implement metering to check the rate of change for a counter, a meter as shown in FIG. 3 or another intermediate storage (e.g., a cache) may be used with the policy implementation module 118 to store count values from the internal ASIC counters included in counter blocks 106, 108, 110, and 112. The intermediate storage may be used in conjunction with the external memory 116, or alternatively, as a separate cache to further reduce any processing time needed for determining count values from the internal ASIC counters included in counter blocks 106, 108, 110, and 112 for implementation of certain policies (e.g., the metering policies P1 and P5 at 418).

The policy implementation module 118 may also implement policies on groups of the internal ASIC counters included in counter blocks 106, 108, 110, and 112, and/or the associated larger counters in the external memory 116. For example, for the foregoing example of the policy that implements a maximum count value of 1 (e.g., a 1 count value that represents an error for a counter that otherwise remains at a 0 count value), the policy implementation module 118 may implement the policy P2 at 410 (or multiple policies) on a group of counters (e.g., counters C65000 to C66000), and/or the associated larger counters in the external memory 116. This provides for granularity in the application of policies to groups of counters.

The policy implementation module 118 may also implement null policies that effectively do not apply any policy to the internal ASIC counters included in counter blocks 106, 108, 110, and 112, and/or the associated larger counters in the external memory 116. For example, counter C2 at 420 may include a null policy P0 at 422 that effectively indicates to the policy implementation module 118 that no policy is to be applied to the counter C2 at 420.

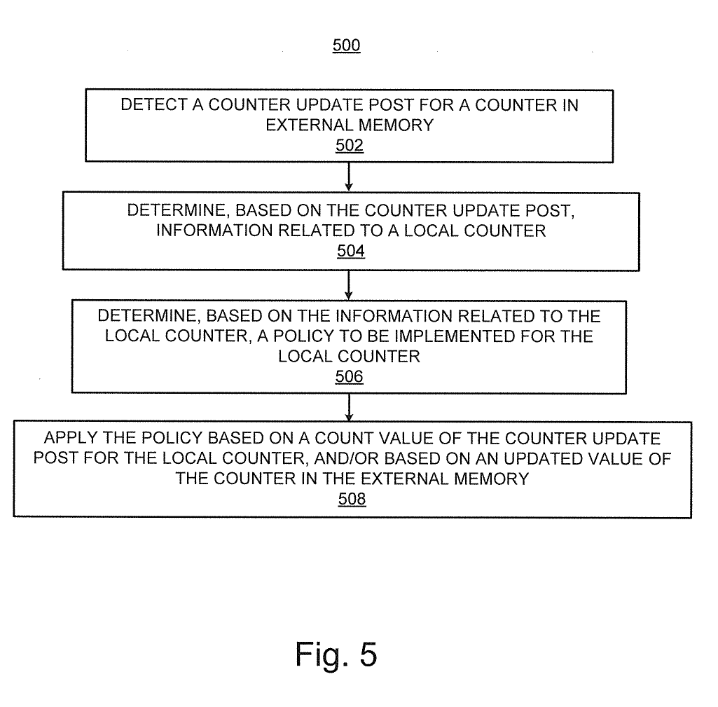

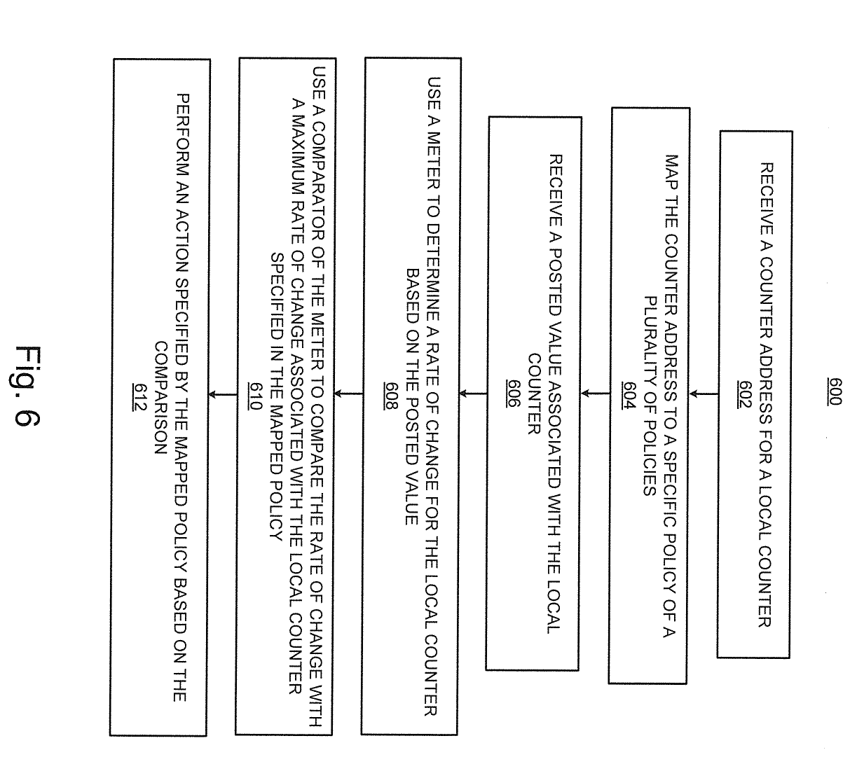

FIGS. 5 and 6 respectively illustrate flowcharts of methods 500 and 600 for counter policy implementation, corresponding to the example of the counter policy implementation apparatus 100 whose construction is described in detail above. The methods 500 and 600 may be implemented on the counter policy implementation apparatus 100 with reference to FIG. 1 by way of example and not limitation. The methods 500 and 600 may be practiced in other apparatus.

Referring to FIG. 5, for the method 500, at block 502, a counter update post for a counter in the external memory 116 may be detected. For example, referring to FIG. 1, the counter updates that are to be posted to counters in the external memory 116 may be detected by the policy implementation module 118.

At block 504, based on the counter update post, information related to a local counter may be determined. For example, referring to FIG. 1, the policy determination module 120 may determine, based on a counter update post, information (e.g., a counter address) related to the particular internal ASIC counter associated with the counter update post.

At block 506, based on the information related to the local counter, a policy to be implemented for the local counter is determined. For example, referring to FIG. 1, the policy determination module 120 may determine, based on a counter update post (e.g., based on the counter address), a policy associated with the particular internal ASIC counter associated with the counter update post.

At block 508, the policy may be applied based on a count value of the counter update post for the local counter, and/or an updated value of the counter in the external memory 116. For example, if the policy implements a maximum count value of one for the local counter that has an initial count value of zero, or generally, if the policy is associated with an error event (e.g., an infrequent event), the method further includes applying the policy based on a count value of the counter update post for the local counter prior to or without determining an updated value of the counter in the external memory 116. If the policy implements a maximum count value of greater than one, the method further includes applying the policy based on an updated value of the counter in the external memory 116.

Referring to FIG. 6, for the method 600, at block 602, a counter address for a local counter may be received. For example, referring to FIGS. 1 and 3, the policy determination module 120 may receive a counter address for a local counter.

At block 604, the counter address may be mapped to a specific policy of a plurality of policies. For example, referring to FIGS. 1 and 3, the counter address may be mapped by the CAM 200 to a specific policy of a plurality of policies of the policies table 202.

At block 606, a posted value associated with the local counter may be received. For example, referring to FIGS. 1 and 3, the ALU 302 of a specific meter may receive a posted value associated with the local counter.

At block 608, a meter may be used to determine a rate of change for the local counter based on the posted value. For example, referring to FIGS. 1 and 3, a meter specified by a meter ID from a mapped policy may be used to determine a rate of change for the local counter based on the posted value.

At block 610, a comparator of the meter may be used to compare the rate of change with a maximum rate of change associated with the local counter specified in the mapped policy. For example, referring to FIGS. 1 and 3, the comparator 308 of the meter specified by the meter ID from the mapped policy may be used to compare the rate of change with a maximum rate of change associated with the local counter specified in the mapped policy.

At block 612, an action specified by the mapped policy based on the comparison may be performed. For example, referring to FIGS. 1 and 3, the action block 312 may perform an action specified by the mapped policy based on the comparison.

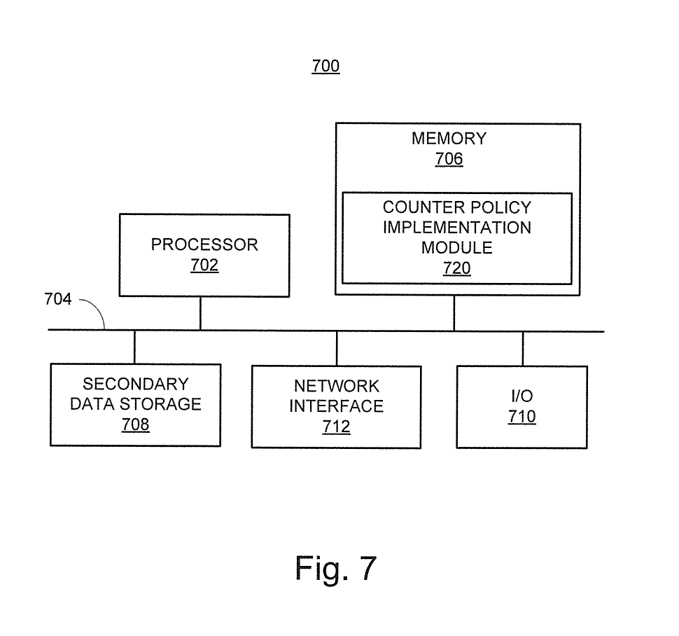

FIG. 7 shows a computer system 700 that may be used with the examples described herein. The computer system represents a generic platform that includes components that may be in a server or another computer system. The computer system 700 may be used as a platform for the apparatus 100. The computer system 700 may execute, by a processor or other hardware processing circuit, the methods, functions and other processes described herein. These methods, functions and other processes may be embodied as machine readable instructions stored on a computer readable medium, which may be non-transitory, such as hardware storage devices (e.g., RAM (random access memory), ROM (read only memory), EPROM (erasable, programmable ROM), EEPROM (electrically erasable, programmable ROM), hard drives, and flash memory).

The computer system 700 includes a processor 702 that may implement or execute machine readable instructions performing some or all of the methods, functions and other processes described herein. Commands and data from the processor 702 are communicated over a communication bus 704. The computer system also includes a main memory 706, such as a random access memory (RAM), where the machine readable instructions and data for the processor 702 may reside during runtime, and a secondary data storage 708, which may be non-volatile and stores machine readable instructions and data. The memory and data storage are examples of computer readable mediums. The memory 706 may include a counter policy implementation module 720 including machine readable instructions residing in the memory 706 during runtime and executed by the processor 702. The counter policy implementation module 720 may include the modules 118, 120, and 122 of the apparatus shown in FIG. 1.

The computer system 700 may include an I/O device 710, such as a keyboard, a mouse, a display, etc. The computer system may include a network interface 712 for connecting to a network. Other known electronic components may be added or substituted in the computer system.

What has been described and illustrated herein is an example along with some of its variations. The terms, descriptions and figures used herein are set forth by way of illustration only and are not meant as limitations. Many variations are possible within the spirit and scope of the subject matter, which is intended to be defined by the following claims—and their equivalents—in which all terms are meant in their broadest reasonable sense unless otherwise indicated.

What is claimed is:

1. A counter policy implementation apparatus comprising:
a policy determination module to receive a counter address for a local counter and to map the counter address to a specific policy of a plurality of policies; and
a policy application module to receive a posted value and a double data rate (DDR) value associated with the local counter, the policy application module including:
a comparator to compare the posted value or the DDR value with a maximum value associated with the local counter specified in the mapped policy; and
an action block to perform an action specified by the mapped policy based on the comparison.

2. The counter policy implementation apparatus of claim 1, wherein the policy determination module further comprises:
a content-addressable memory (CAM) to map the counter address to the specific policy of the plurality of policies.

3. The counter policy implementation apparatus of claim 1, further comprising:
a DDR counter update engine to forward the posted value and the DDR value associated with the local counter to the policy application module.

4. The counter policy implementation apparatus of claim 3, further comprising:
a counter block including an arithmetic logic unit (ALU) and a counter update first in first out (FIFO) to forward the posted value to the DDR counter update engine.

5. The counter policy implementation apparatus of claim 1, wherein the policy application module further comprises:
a multiplexer to determine whether to forward the posted value or the DDR value to the comparator for comparison to the maximum value based upon the mapped policy.

6. The counter policy implementation apparatus of claim 1, wherein the mapped policy is a maximum counter value based policy.

7. A counter policy implementation apparatus comprising:
a policy determination module to receive a counter address for a local counter to and to map the counter address to a specific policy of a plurality of policies; and
a policy application module to receive a posted value associated with the local counter, the policy application module including:
a meter to determine a rate of change for the local counter based on the posted value, the meter including a comparator to compare the rate of change with is a maximum rate of change associated with the local counter specified in the mapped policy; and
an action block to perform an action specified by the mapped policy based on the comparison.

8. The counter policy implementation apparatus of claim 7, wherein the policy determination module further comprises:
a content-addressable memory (CAM) to map the counter address to the specific policy of the plurality of policies.

9. The counter policy implementation apparatus of claim 7, further comprising:
a DDR counter update engine to forward the posted value associated with the local counter to the policy application module.

10. The counter policy implementation apparatus of claim 9, further comprising:
a counter block including an arithmetic logic unit (ALU) and a counter update first in first out (FIFO) to forward the posted value to the DDR counter update engine.

11. The counter policy implementation apparatus of claim 7, wherein the policy application module further comprises:
a plurality of meters associated with the policies.

12. The counter policy implementation apparatus of claim 7, wherein the meter includes:
an arithmetic logic unit (ALU) to receive posted values associated with the local counter;
an accumulator to store the posted values received by the ALU; and
a timer to monitor an update rate associated with the local counter.

13. The counter policy implementation apparatus of claim 7, wherein the mapped policy is a maximum rate of change based policy.

14. A method of counter policy implementation, the method comprising:
detecting a counter update post for a counter in external memory;
determining, based on the counter update post, information related to a local counter;
determining, based on the information related to the local counter, a policy to be implemented for the local counter; and
applying the policy based on at least one of:
a count value of the counter update post for the local counter; and
an updated value of the counter in the external memory.

15. A method of counter policy implementation, the method comprising:
receiving a counter address for a local counter;
mapping the counter address to a specific policy of a plurality of policies;
receiving a posted value associated with the local counter;
using a meter to determine a rate of change for the local counter based on the posted value;
using a comparator of the meter to compare the rate of change with a maximum rate of change associated with the local counter specified in the mapped policy; and
performing an action specified by the mapped policy based on the comparison.
